(19) United States
(12) Patent Application Publication
(10) Pub. No.: US 2026/0300522 A1
(43) Pub. Date: Oct. 1, 2026

(54) ARCHIVING ENCRYPTED MESSAGE GROUPS

(71) Applicant: SENTRIQS, INC., Savannah, GA (US)

(72) Inventors: Paul DILLON, Erie, PA (US); Damien FORTUNE, Savannah, GA (US)

(73) Assignee: SENTRIQS, INC., Savannah, GA (US)

(21) Appl. No.: 19/094,555

(22) Filed: Mar. 28, 2025

(51) Int. Cl. G06F 21/62; H04L 9/00

(52) U.S. Cl. CPC G06F 21/6209; H04L 9/008

(57) ABSTRACT

Methods and systems are disclosed herein for a message archiving system that may first be enabled for a particular group. Once enabled, the message archiving system may start archiving the messages received by the members of the group so that those messages may be reviewed for various purposes. To enable archiving, the message archiving system may, upon receiving a command to enable archiving, initiate a group update. The group update may generate a binary tree for the group on the archiving device. The binary tree enables the archiving device to receive and decrypt messages received by the group. The message archiving system may then resolve a public and private key for encrypting and decrypting messages once they have been designated for archiving.

### BACKGROUND

Many messaging applications exist that enable users to communicate via the Internet. Those messaging applications include an ability to communicate with a single person and a group of people. Furthermore, those applications employ various encryption technologies to enable secure communications for both usage in person-to-person communications and person-to-group communications. Some applications use Message Layer Security (MLS) encryption to perform encryption on person-to-group communications. MLS enables encryption of person-to-group communications. However, in certain situations, absolute privacy (e.g., due to encryption) may be superseded by other requirements, and thus, the ability to archive messages even when they are encrypted may be very important. The MLS protocol is unable to handle message archiving. Therefore, a mechanism is required to implement archiving functions in groups where encrypted messages are not visible to members outside of the group.

### SUMMARY

To address these and other issues, an end-to-end mechanism is disclosed herein for archiving encrypted messages. A message archiving system may be used to perform the operations disclosed here. The message archiving system may reside on a server or another suitable device.

The message archiving system may be first enabled for a particular group. Once enabled, the message archiving system may start archiving the messages received by the members of the group so that those messages may be reviewed for various purposes. To enable archiving, the message archiving system may, upon receiving a command to enable archiving, initiate a group update to add a message archiver (e.g., an account and/or device) to the group so that the archiving device and/or account are able to receive group messages. The group update, when initiated, may generate a binary tree for the group on the archiving device or a device being used by an archiver account. The binary tree enables the archiving device and/or archiver account to receive and decrypt messages received by the group. The message archiving system may then generate a public and private key for encrypting and decrypting messages once they have been designated for archiving. In some instances, the public and private keys may be pre-generated and stored without use until archiving is enabled on the group. At the time, the key is accessed and used as described below. In some embodiments, the public/private key pair may be used for multiple groups. The public key is published onto a server so that the public key is used to encrypt the messages being archived. The private key may be stored in a key vault or another location that may be accessed by an administrator account so that the archived messages are enabled to be decrypted for viewing.

The message archiving system may perform the following operations when enabling archiving for a group. The message archiving system may receive an archiving request to enable archiving for a group. The group may be a group that has a corresponding binary tree with multiple leaf nodes such that each leaf node represents a corresponding user or user device within the group. In some embodiments, the request may be received at an archiving device and be sent from an administrator device associated with a group administrator. For example, a group administrator may send a request because of a change in policy requiring a particular group to be archived. In some embodiments, the request may be received at the time the group is created, with the group creation request including a command to enable archiving of the group.

The message archiving system may then initiate a group update to add the archiver (e.g., an archiving device and/or an archiver account) to the group. In particular, the message archiving system may initiate a group update to add the archiving device to the group as a member of the group. For example, the archiving device and/or the archiver account may be added to the binary tree as a new leaf node, thereby becoming a new member of the group. As a new member of the group, the archiving device and/or the archiver account may receive all the messages addressed to the group. For example, if the group has thirty members, the archiving device and/or the archiver account may become the thirty-first member of the group.

Furthermore, the message archiving system may cause a public and a private key to be generated for the group so that the received message may be encrypted as part of the archiving process and may be decrypted as part of message viewing process. In particular, the message archiving system may transmit a command to the administrator device to resolve an archiver private key for decrypting archived messages associated with the group and an archiver public key for encrypting the archived messages associated with the group. For example, the public/private key pair may be generated at the time archiving is enabled. In another example, the public/private key pair may be generated prior to archiving being enabled and may be stored. In this instance there may be no command transmission to the administrator device, as when the enablement process is initiated the public/private key pair may be retrieved from storage. In some embodiments, the administrator device may be the device that transmitted the request to enable archiving and thereby caused the group update to be initiated. The administrator device may generate the archiver public key and the archiver private key. The archiver public key may be sent to the server so that the server is able to encrypt the message as part of the archiving process. In some embodiments, the archiver private key is kept on an administrator's device or stored in a special vault.

In some embodiments, both the archiver public key and the archiver private key may be sent to the server so that the server is able to encrypt messages to be archived and to decrypt archived messages for viewing. Thus, the message archiving system may receive, in response to the command, the archiver private key and the archiver public key. In some embodiments, the message archiving system may only receive the archiver public key (without receiving the archiver private key) and may publish the archiver public key for use to encrypt messages during the archiving process. The archiver private key may be stored in a security location (e.g., on an administrator's device or another suitable device) to be used for decrypting messages during viewing of archived messages. Thus, the message archiving system may cause the archiver private key to be stored in a key vault in association with a group identifier corresponding to the group. The key vault may be hosted on an administrative device, a server, or another suitable device.

In some embodiments, the message archiving system may publish the archiver public key in association with the group identifier. The group identifier may be used to retrieve the archiver public key for encrypting received messages. For example, when the archiving device receives an encrypted message to be archived, the archiving device may use the binary tree to decrypt the message and then determine to which group the encrypted message was sent. This determination may include retrieving the group identifier from the message metadata of the encrypted message. The message archiving system may then use the group identifier to determine the archiver public key associated with the group and may then encrypt the message using the archiver public key when the message is archived.

Archived messages for a particular group may be reviewed after they are archived. The review process may be initiated by an administrative user (e.g., a user that is enabled to access the archiver private key). Thus, the message archiving system may receive a query to view one or more archived messages. The query may include the group identifier and a requesting user identifier. For example, the message archiving system may receive a query to view messages for a particular group at a particular time interval (e.g., for a one-week period). The query may include the group identifier that identifies a group for the requested messages and a user identifier of the administrative user requesting the viewing. In some embodiments, the query may include other parameters such as date/time information, sender information, and/or other suitable information.

The message archiving system may determine, based on the requesting user identifier, whether a requesting user is authorized to view the archived messages associated with the group. For example, the message archiving system may determine whether the user identifier corresponds to a user that has administrative permissions to view the messages for the group. In some embodiments, the authorization test may be having access to the archiver private key. For example, the message archiving system may encrypt a string or another suitable object with the archiver public key so that the requester is able to decrypt the string or another suitable object. If the decryption is correct, the message archiving system may determine that the request is authorized.

Based on determining that the requesting user is authorized to view the archived messages for the group, the message archiving system may identify, using the group identifier in metadata associated with the group, one or more encrypted files responsive to the query or matching the query. For example, the message archiving system may query the metadata for the group's archive(s) and identify messages that are being requested. In some embodiments, the messages may be stored within archived files for better management. Thus, the message archiving system may then transmit the one or more encrypted files to the requesting user. The requesting user may then use the archiver private key for the group to decrypt the files and view the message. However, if the requesting user does not possess the archiver private key, the messages will not be decrypted and may not be viewed.

Once the group is configured for archiving, the archiving device or another suitable device may start archiving the encrypted messages received for the group. As described above, the archiving device may be configured within the binary tree associated with a group as a member of the group. Thus, the message archiving system may receive an encrypted message to be assigned to or archived by the archiving device. In some embodiments, the message may be received at an archiving device from a server that is processing messages for the group. The archiving device may be a different physical device from the server that is processing the messages. However, in some embodiments, the archiving device may be a software that resides on the server itself.

When the message is received, the message archiving system may identify the target group for the message. In particular, the message archiving system may determine a group identifier for a group to which the encrypted message is directed and a user identifier corresponding to a user that sent the encrypted message. The group may be one of a plurality of groups assigned to the archiving device. In some embodiments, the group identifier and the user identifier may be extracted from message metadata associated with the encrypted message. For example, the encrypted message may be received, and certain metadata of the message may be received in clear text. Thus, the message archiving system may determine a particular group to which the message is sent. A particular group may be a group of thirty members with a particular group identifier.

When the group is identified, the message archiving system may use the binary tree associated with the group to decrypt the encrypted message that is received for the group. As discussed above, the message archiving system may have access to the binary tree because the archiving device and/or account is a member of the group. Thus, the message archiving system may access, based on the group identifier, a binary tree associated with the group. The binary tree may store a plurality of user identifiers of a plurality of users within the group (e.g., user identifier associated with the member of the group). In addition, the binary tree may store a plurality of key generation secrets. Each key generation secret may be a last generated key generation secret for a corresponding user. For example, each group that is being archived may have a corresponding binary tree, which may be hosted on a server, an archiving device, or different archiving devices. The appropriate binary tree may be selected based on the group identifier.

When the appropriate binary tree has been selected, the message archiving system may initiate the process of decrypting the message so the message can be archived. The message archiving system may locate, within the binary tree based on the user identifier, a leaf node representing the user. For example, the user may be a member of the group that has sent the message to the group. The user may be associated with a user identifier received together with the message. Using the user identifier, the message archiving system may locate the leaf node associated with the user. In some embodiments, the user identifier may be a device identifier of the user so that the leaf node may correspond to the device of the user.

When the leaf node has been located, the message archiving system may retrieve a key generation secret from the node in order to create a key for decrypting the message. In particular, the message archiving system may retrieve, from the leaf node, a latest key generation secret associated with the user. The message archiving system may then generate, using a key generation algorithm, a subsequent key generation secret and a subsequent decryption key. In some embodiments, the subsequent key generation secret and the subsequent decryption key may have also been separately generated on a device of the user, such that the subsequent decryption key was used to encrypt the encrypted message on the device of the user. For example, when the user has initiated message transmission, the user's device may have used the user's leaf node within the binary tree to generate an encryption key using the next key generation secret (e.g., generated using an algorithm sometimes referred to as a ratchet). The message archiving system may use the same process to generate a decryption key (which may be the same as an encryption key) for decrypting the message. Thus, the message archiving system may decrypt the encrypted message using the subsequent decryption key to generate a decrypted message.

When the message has been decrypted, the message archiving system may proceed with the archiving process. In particular, the message archiving system may move the decrypted message into an encryption location such as encryption queue. The encryption location may be a physical location on disk or a location in memory. The encryption queue may be a data structure that stores a plurality of decrypted messages for the group. The decrypted message may be placed in the encryption location with a number of other messages for the same group. The messages may be stored in the encryption location so that they may be archived together in the same file. This process enables better management of the archive and the archive metadata that describes the metadata associated with each archived message. For example, each message may be associated with a corresponding send date, a corresponding sender display name, a corresponding recipient display name, and/or other suitable parameters. The messages may stay in the queue for a particular amount of time until the queue reaches a particular size or until another condition is met.

Once the message is ready to be archived, the message archiving system may encrypt, using an encryption public key generated for a group administrator, the decrypted message and the plurality of decrypted messages into an encrypted file. Furthermore, the message archiving system may store the encrypted file, wherein the encrypted file is accessed by the archiving device. Furthermore, when the message is ready to be archived, the message archiving system may send a message to the server that the message is ready to be stored.

In some embodiments, the server may delay sending the message to members of the group until the message is ready to be stored (e.g., ready to be archived). In particular, the message archiving system may, based on moving the decrypted message into the encryption location (e.g., encryption queue), transmit an acknowledgment to the server that the encrypted message was received. The encrypted message may not be sent to group members until the acknowledgment is received by the archiving device.

Various other aspects, features, and advantages of the disclosure will be apparent through the detailed description of the disclosure and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example computing environment for enabling group archiving for a group and archiving encrypted messages sent to that group, in accordance with some embodiments of this disclosure.

FIG. 2 illustrates an archiving request, in accordance with some embodiments of this disclosure.

FIG. 3 illustrates an excerpt of a data structure for storing metadata, in accordance with some embodiments of this disclosure.

FIG. 4 shows an example computing system that may be used, in accordance with some embodiments of this disclosure.

FIG. 5 shows an example flowchart of operations for enabling archiving for a group, in accordance with some embodiments of this disclosure.

FIG. 6 shows an example flowchart of operations for performing archiving operations, in accordance with some embodiments of this disclosure.

### DETAILED DESCRIPTION

In the following description, for the purposes of explanation, numerous specific details are set forth in order to provide a thorough understanding of the disclosure. It will be appreciated, however, by those having skill in the art, that the disclosure may be practiced without these specific details or with an equivalent arrangement. In other cases, well-known structures and devices are shown in block diagram form to avoid unnecessarily obscuring the disclosure.

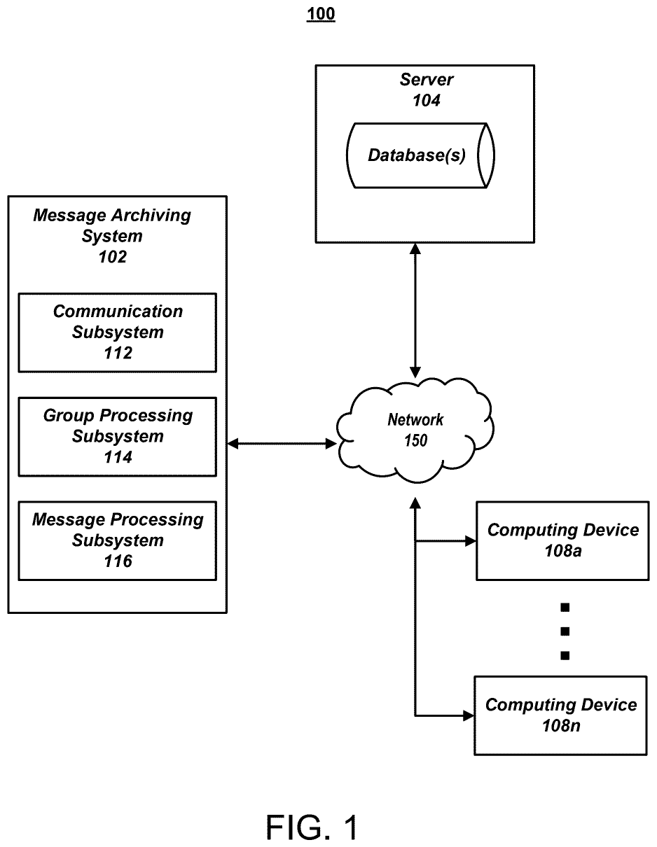

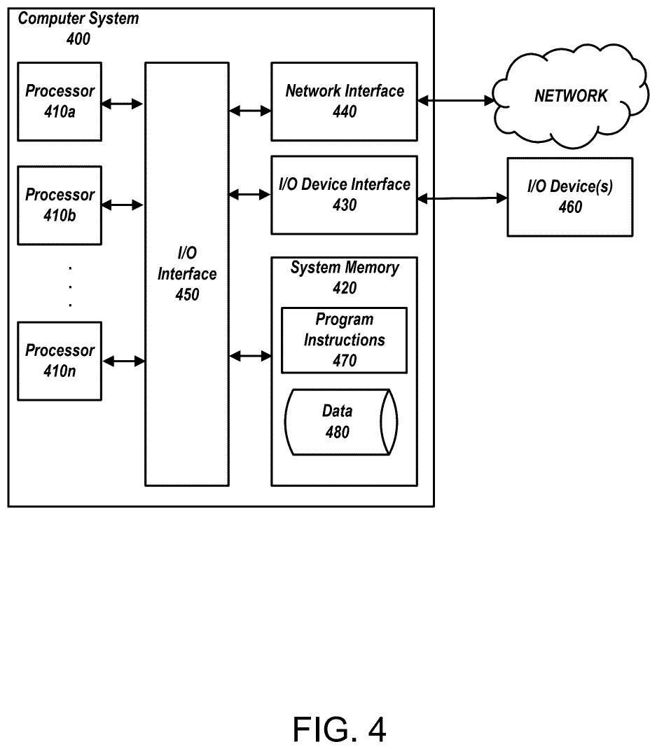

FIG. 1 shows an example environment 100 for enabling group archiving for a group and archiving encrypted messages sent to that group. Environment 100 includes message archiving system 102, server 104, and computing devices 108a-108n. Message archiving system 102 may execute instructions for enabling group archiving for a group and archiving encrypted messages sent to that group. Message archiving system 102 may include software, hardware, or a combination of the two. For example, message archiving system 102 may be a physical computing device or a virtual computing device that is running on a physical computing device. Message archiving system 102 may be hosted on a personal computer, a smartphone, a laptop computing device, an electronic tablet, or another suitable computing device. In some embodiments, message archiving system 102 may be hosted on a cloud-computing device and may be accessed by a thin client. Some components of message archiving system 102 may be hosted on a server device (e.g., server 104). Message archiving system 102 may include communication subsystem 112, group processing subsystem 114, and message processing subsystem 116. Message archiving system 102 may include other components (e.g., as described in FIG. 4).

Communication subsystem 112 may include software components, hardware components, or a combination of both. For example, communication subsystem 112 may include a network card (e.g., a wireless network card and/or a wired network card) that is coupled with software to drive the card. Group processing subsystem 114 may include software components, hardware components, or a combination of both. For example, group processing subsystem 114 may include software components that access data in memory and/or storage and may use one or more processors to perform its operations. Message processing subsystem 116 may also include software components, hardware components, or a combination of both. For example, message processing subsystem 116 may include software components that access data in memory and/or storage and may use one or more processors to perform its operations.

Server 104 may host server components associated with message archiving system 102 as well as other server components. In some embodiments, server 104 may host the archived messages (e.g., encrypted files storing the archived messages). In addition, server 104 may store archive metadata that indicates which encrypted files host which messages. For example, server 104 may store metadata that indicates date and time of messages within each encrypted file, in addition to sender and other metadata. In some embodiments, server 104 may process messages as they are being sent by members of groups and may forward messages to the recipients.

In some embodiments, group processing subsystem 114 may be hosted on a device different from communication subsystem 112 and message processing subsystem 116. For example, group processing subsystem 114 may be hosted on a client device (e.g., laptop computer, electronic tablet, or another suitable client device). The client device may be associated with an administrator of the group and may be used to enable archiving for a particular group. In some embodiments, portions of group processing subsystem 114 may be hosted on server 104. For example, when an administrator is searching for messages within the archive, the query may be received from the administrator's device (e.g., a client device) and may be applied to encrypted files stored on server 104. Group processing subsystem 114 may be hosted either on the same client device or may be hosted on a different server device.

Server 104 may include software, hardware, or a combination of the two. For example, server 104 may be a physical server or a virtual server that is running on a physical computer system. Network 150 may be a local area network, a wide area network (e.g., the Internet), or a combination of the two. Computing devices 108a-108n may be devices belonging to group members and/or other suitable devices that may host user applications. Computing devices 108a-108n may include components similar to components of message archiving system 102.

The operations described below may use the following concepts related to encryption of group messages. In an established group, each group member may maintain (e.g., within a web browser or another type of storage) cryptographic information needed to (1) encrypt its own messages and (2) decrypt the messages received from other group members. The encryption mechanism may employ a traditional symmetric key encryption algorithm, which may require the sender and receiver(s) to have access to a common, single shared key that may be an input to the encryption and decryption processes. Several mechanisms may be used to safely and securely distribute to all group members the data for establishing the set of shared keys that may be employed when invoking the symmetric key encryption.

The first mechanism may involve a concept referred to as a “ratchet.” As referred to herein, the term ratchet refers to a mechanism that takes one secret (e.g., a key generation secret) as input and deterministically produces two outputs: (1) a secret to be used with the symmetric key encryption algorithm (e.g., an encryption/decryption key) and (2) a secret intended to be cycled back as the next input to the ratchet mechanism (the new key generation secret). With this mechanism, a sender and each recipient may exchange an initial shared secret to be used as the first input to their respective copies of a ratchet, and then each independently produces the same sequence of shared secrets where the sender may utilize one output from the ratchet to produce an encrypted message and the recipient may utilize that output to decrypt the message before they both discard the secret and move on to the next secret in the sequence.

Each group member may maintain a set of ratchets, assigning one to each group member such that the assigned ratchet may be utilized when the corresponding group member sends a message. In this way, the system may ensure that each member receives the initial shared secret for each of the ratchets in the group.

To that end, the second mechanism may employ a binary tree structure that allows for the efficient computation of these initial secrets. In some embodiments, within the binary tree structure, the ratchets may be arranged for the group members as leaves of the tree. Then, starting with an initial, single input secret (e.g., key generation secret) assigned to the root of the tree, a messaging system may deterministically derive secrets to assign to each of the root's children in a fashion similar to the derivation made by a ratchet. This process may then be repeated with the children of the root's children down the tree until a unique secret (e.g., key generation secret) is assigned to each of the leaves of the tree. Each unique secret may then serve as the initial input to the ratchet corresponding to the group member at that position in the binary tree. Thus, a single initial secret, the root secret, may be used to derive the set of secrets that initialize the ratchets within the binary tree.

Furthermore, the messaging system may distribute the root secret to all group members without disclosing the secret to any unintended third party, which is achieved utilizing a key exchange or key encapsulation mechanism, but one where the public/private key pair used to secure the root secret is not chosen randomly. Instead, the key pair may also be deterministically derived from other secrets.

A third mechanism may again employ the same binary tree to compute (1) secrets used to derive the root secret and (2) a set of public/private key pairs assigned to the interior nodes of the tree and used to encapsulate these secrets for distribution to other group members. The mechanism may cause the binary tree to be unbalanced and left-filled, such that all nodes other than the root have a sibling. With an existing group, a computing device of each group member (e.g., computing devices 108a-108n) may store the position of its own leaf node in the binary tree and may be in possession of the private keys assigned to the parent of that leaf node and each subsequent parent up to the root node. In addition, each computing device may store its own public/private key pair assigned to its own leaf node, which may formally identify the member to the group. Each computing device may also be in possession of the public keys assigned to all the nodes in the binary tree.

When one group member initiates an action for which the ratchets may be (re)initialized, the mechanism may utilize a path in the binary tree from the leaf corresponding to this acting group member up to the root. The parent of the leaf in this path, as well as each parent up to the root, may have one inactive child, the child that is not a member of this path. The public key for this inactive child may be used with the key encapsulation algorithm to generate a new secret (e.g., key generation secret) to assign to the parent, or a new secret (e.g., new key generation secret) may randomly be chosen and encrypted with the public key. The messaging system may add the encrypted secret to a message to be distributed to the other group members. The secret may also be used to derive a new public/private key pair to assign to the parent. The secret may also be used as the input to derive an output secret that is assigned to the parent of the parent. The messaging system may repeat the process for each parent in the path using the previous step's output secret to derive the new key pair and next output secret. The final output secret may then be defined as the root secret described above. The result of this mechanism is (1) a message containing a list of novel secrets, each encrypted with a different public key, and (2) a new set of key pairs for the nodes of the tree along this path.

When the messaging system receives the message, another group member may be assured that at least one private key positioned along its path from leaf to root corresponds to one of the public keys used to encrypt the secrets in the message. The messaging system may use this private key to decrypt the corresponding secret, thereby allowing the member to complete the operation, repeatedly deriving secrets and key pairs for nodes in a local copy of the binary tree up to the root. The messaging system may ultimately arrive at the original root secret derived by the sender.

As discussed above, certain groups may need to be archived, for example, based on policy or another suitable rule. It would be difficult to archive this type of group because every message is encrypted with a different encryption key. Thus, when a group is set up to be archived, a way around this issue is that the archiver account becomes a member of the group so that each message sent is received by the archiver and may be decrypted by the archiver. Message archiving system 102 (e.g., via group processing subsystem 114) may perform the following operations to archive messages for a group as described above. To initiate archiving for a group, a request may be received. In particular, group processing subsystem 114 may receive an archiving request to enable archiving for a group. As discussed above, the group is associated with a binary tree that includes a plurality of leaf nodes, with each leaf node representing a corresponding user within the group. In some embodiments, each leaf node may represent a particular user device. The archiving request may be initiated by an administrative user or by an administrative system. For example, a policy change may require that one or more groups, as described above, are enabled for archiving. In another example, group archiving may be enabled when the group is created. Thus, the operations described below may be initiated during group creation.

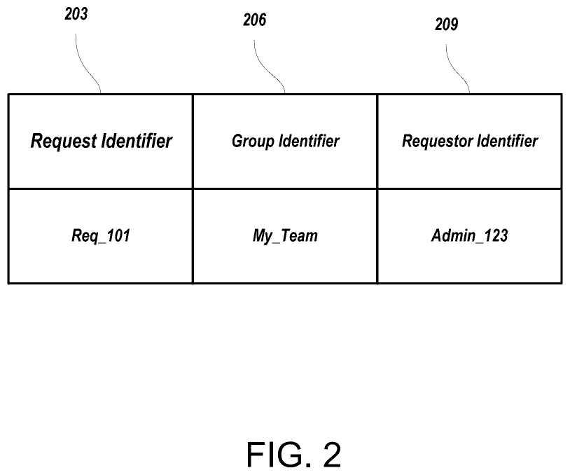

FIG. 2 illustrates an example archiving request 200. The archiving request may include a number of fields. For example, the archiving request may include field 203 that may store a request identifier. Field 206 may store a group identifier, and field 209 may store a request identifier. For example, a request identifier may be an alphanumeric string or another suitable identifier. A group identifier may be a group name, group address, or another suitable identifier. In some embodiments, other fields may be added to the archiving request.

When the request for enabling group archiving is received, group processing subsystem 114 may add an archiver to the group. In particular, group processing subsystem 114 may initiate a group update to add an archiver to the group as a member of the group. As a result of the update, the archiver may be added to the binary tree as a new leaf node. The archiver may be an account and/or a device (e.g., a server executing a software module). In some embodiments, the archiver may be a combination of an account and a software module that may use that account to receive and decrypt messages from the group.

When the group update operation is initiated by a server that processes group messages, the archiver (e.g., the archiving device) may need to perform an operation for adding itself to the group. The server may send the data needed to perform the operation. Accordingly, the archiver (e.g., the archiving device) may be configured to act as a client device that receives group messages. Thus, to perform the updated operation, the archiver may perform the following operations. The archiver may receive an update request for performing a group update operation. The update request may include one or more instructions for generating the binary tree that stores various information for the group. For example, the update request may include a plurality of user identifiers of a plurality of users within the group and a plurality of key generation secrets. In some embodiments, each key generation secret may be a last generated key generation secret for the corresponding user. In some embodiments, the update request may include a master secret that may be used as a root secret to generate all other secrets within the binary tree. Group processing subsystem 114 may then generate the binary tree for the group on the archiving device. The binary tree may include a leaf node for the archiver (e.g., the archiving device).

When the archiver is added to the group, the archiver is now ready to receive encrypted messages addressed to the group and may be able to decrypt the encrypted messages to archive those messages. However, to archive messages, the archiver may need an encryption key to encrypt the messages being archived and a decryption key to enable the archived message to be viewed. However, those keys may need to be generated on a device belonging to the administrator of the group and not the archiver itself. Accordingly, group processing subsystem 114 may transmit a command to an administrator device to resolve an archiver private key for decrypting archived messages associated with the group and an archiver public key for encrypting the archived messages associated with the group. For example, the public/private key pair may be generated at the time archiving is enabled. In another example, the public/private key pair may be generated prior to archiving being enabled and may be stored. When the enablement process is initiated the public/private key pair may be retrieved from storage. In some embodiments, the command may be transmitted to the device that requested that archiving for the group be enabled. In yet some embodiments, the command may be transmitted to a device of a user that has been designated as the administrator or owner of the group. In yet some embodiments, instead of having an archiver public key and an archiver private key, group processing subsystem 114 may instruct the administrator device to create a single key that may be used to both encrypt and decrypt messages.

In some embodiments, group processing subsystem 114 may perform the following operations to transmit the command to the administrator device to generate the archiver private key and the archiver public key. Group processing subsystem 114 may retrieve, from the archiving request, a user identifier associated with an administrator requesting that archiving be enabled. For example, if an administrator of the group has requested that archiving is to be enabled, the user identifier of the administrator may be sent as part of the metadata together with the request. Thus, group processing subsystem 114 may retrieve the user identifier from the metadata of the request.

Group processing subsystem 114 may then use the user identifier to determine a device associated with the administrator. In particular, group processing subsystem 114 may identify, within a user dataset based on the user identifier, an address associated with the administrator device. Group processing subsystem 114 may then transmit the command to the address associated with the administrator device.

In some embodiments, group processing subsystem 114 may, in response to the command, receive the archiver public key. For example, when the administrator device generates the archiver public key and the archiver private key, the administrator device may publish or otherwise transmit the archiver public key to the archiver (e.g., the archiving device). The archiver public key may be published together with a group identifier so that whenever a message for the group is to be archived, the archiver may use the group identifier (e.g., extracted from the message metadata) to identify the corresponding archiver public key so that the message can be encrypted during the archiving process. In some embodiments, the administrator device may send both the archiver public key and the archiver private key to be stored. For example, the archiver (e.g., the archiving device) may host a key vault where all the private keys are stored for different groups so that different administrative users are able to log in to the archiving device and view messages.

In some embodiments, each archiver private key may be stored at an administrator device where it was generated. Thus, in these instances, only the administrator that enabled archiving for the group will be able to view the archived messages. The administrator device may include a key vault where the key may be stored. In some embodiments, the archiving device may include a mechanism for viewing the messages. For example, the archiving device may host a graphical user interface and backend code enabling a user to view/review archived messages for various groups. The user may be able to select a group and other criteria. The user may then use the private key within the user's key vault (e.g., on the user device) to decrypt any encrypted files received as a result of the search. Thus, a portion of message archiving system 102 may be hosted on a user device.

Group processing subsystem 114 may then cause the archiver private key to be stored. In particular, group processing subsystem 114 may cause the archiver private key to be stored in association with a group identifier corresponding to the group. As discussed above, the archiver private key may be stored on a user's device (e.g., on a device that generated the archive private key), on the archiver itself, or on another suitable device. Furthermore, group processing subsystem 114 may publish the archiver public key to be used with the group identifier. For example, group processing subsystem 114 may cause the administrator device to transmit the archiver public key and the corresponding group identifier to the archiver so that the archiver is able to store archiver public key in memory in association with the group identifier. In some embodiments, group processing subsystem 114 may store the archiver public key in a database table together with the group identifier so that when a message or a group of messages for a particular group are ready to be archived, group processing subsystem 114 may retrieve the archiving public key using the group identifier.

When the messages for a group have been archived, they may be retrieved from the archive so they can be reviewed. Message processing subsystem 116 may perform the retrieval operations discussed herein. Message processing subsystem 116 may receive a query to view one or more archived messages. The query may include the group identifier and a requesting user identifier. For example, message processing subsystem 116 may generate for display to a user (e.g., an administrator of the group) a graphical user interface where the user may be able to select a group, a time period, and/or other criteria for messages to view. When the user selects the criteria, that criteria may be submitted to message processing subsystem 116.

Message processing subsystem 116 may then determine whether the user is authorized to view the messages. In particular, message processing subsystem 116 may determine, based on the requesting user identifier, whether a requesting user is authorized to view the archived messages for the group. Message processing subsystem 116 may use various mechanisms to determine whether the user is authorized. In some embodiments, message processing subsystem 116 may perform the following operations to determine whether the user is authorized. Message processing subsystem 116 may search, using the requesting user identifier, for a user entry associated with the group. For example, the group may be associated with a data structure that may store all user identifiers for the members of the group. Each member may have a particular type of membership (e.g., administrator, non-administrator, etc.). In some embodiments, each user within the group data structure may have a flag indicating whether the user is an administrator. In yet some embodiments, only administrators may be flagged.

Message processing subsystem 116 may, upon locating the user identifier, determine whether the user is authorized. In particular, message processing subsystem 116 may determine whether the user entry includes a permission flag indicating that the requesting user is allowed to view the archived messages for the group. As discussed above, the flag may indicate whether the user is an administrator. In some embodiments, the flag may be specific for an archive reviewer. Thus, the user may have a role called archive reviewer, allowing the user access to the messages.

In some embodiments, message processing subsystem 116 may use the archiver public key and the archive private key for the group to determine whether the user is authorized. Message processing subsystem 116 may identify, using the group identifier, the archiver public key for the group. For example, message processing subsystem 116 may perform a lookup, using the group identifier, for the archiver public key. Message processing subsystem 116 may then generate an authorization token (e.g., an alphanumeric string) for authorizing the requesting user. The authorization token may be generated using a random number generator or using another suitable mechanism. Message processing subsystem 116 may then encrypt, using the archiver public key, an authorization token into an encrypted token. For example, message processing subsystem 116 may encrypt the token using the archiver public key so that a proper private key may be used to decrypt the encrypted token.

Message processing subsystem 116 may then transmit, to the requesting user, a request to authorize. The request may include the encrypted token so that it may be decrypted. For example, message processing subsystem 116 may send the encrypted token (e.g., together with the group identifier) to the device requesting to view the messages with a command to decrypt the token. The requesting device may use the group identifier to retrieve the corresponding archive private key and may decrypt the token. Once the token is decrypted, the requesting device may send the token back for the archiver to compare the token with the one that was generated. Message processing subsystem 116 may determine, based on a response token received from the requesting user, whether the requesting user is authorized. For example, if the requesting device does not have the archiver private key, then the token will not be correctly decrypted. Accordingly, message processing subsystem 116 may not give permission to such a device. However, if the token is properly decrypted, message processing subsystem 116 may determine that the user is authorized and proceed with the process.

Based on determining that the requesting user is authorized to view the archived messages for the group, message processing subsystem 116 may identify, using the group identifier in metadata associated with the group, one or more encrypted files responsive to the query or matching the query. For example, as discussed above, each message may be stored in an encrypted file containing a number of messages. Each file may have associated metadata (e.g., in a database) that may have message metadata for the messages stored in the file. For example, the metadata may be stored in a data structure such as a database table and include information such as a message identifier, date and time of the message, the sender of the message, the target group of the message, and/or other suitable parameters. Thus, message processing subsystem 116 may use the criteria received within the request to search the metadata to determine which encrypted files are responsive to the criteria. Message processing subsystem 116 may then transmit the one or more encrypted files to the requesting user.

In some embodiments, message processing subsystem 116 may process the message viewing request using the following operations. Message processing subsystem 116 may cause the one or more encrypted files to be decrypted. For example, message processing subsystem 116 may request the archiver private key from either the key vault or from the requesting user's device and use that archiver private key to decrypt the encrypted file or files.

Message processing subsystem 116 may store one or more decrypted messages retrieved from the one or more encrypted files in a temporary location. For example, message processing subsystem 116 may create a folder on the archiving device and temporarily store the encrypted files in that folder and decrypt those files. In some embodiments, before decrypting the encrypted files, message processing subsystem 116 may determine which messages are stored in which encrypted files.

Message processing subsystem 116 may then identify which messages within the encrypted file or files match the criteria. In particular, message processing subsystem 116 may select, based on criteria within the query, a plurality of messages matching the query. For example, one or more of the encrypted files may have messages that are responsive to the query or match the query and messages that are not responsive to or do not match the query. Thus, message processing subsystem 116 may want to only retrieve messages that are responsive to or match the query. Message processing subsystem 116 may determine (e.g., based on the message identifier and the metadata) those messages that are responsive to or match the query. Message processing subsystem 116 may then retrieve those messages.

In some embodiments, message processing subsystem 116 may determine which users correspond to which messages. Thus, message processing subsystem 116 may retrieve for the plurality of messages a plurality of user identifiers. For example, each message may be stored with metadata indicating the sender of the message, which may be a user identifier. The user identifier may be linked to a user object within the database. The user object may include user identifying information such as name, nickname(s), and/or other information. Thus, message processing subsystem 116 may retrieve, for each user identifier, a corresponding username. Message processing subsystem 116 may then, when displaying the messages, remove the user identifier with a corresponding username and/or one or more nicknames. Thus, message processing subsystem 116 may modify the plurality of messages with each corresponding username.

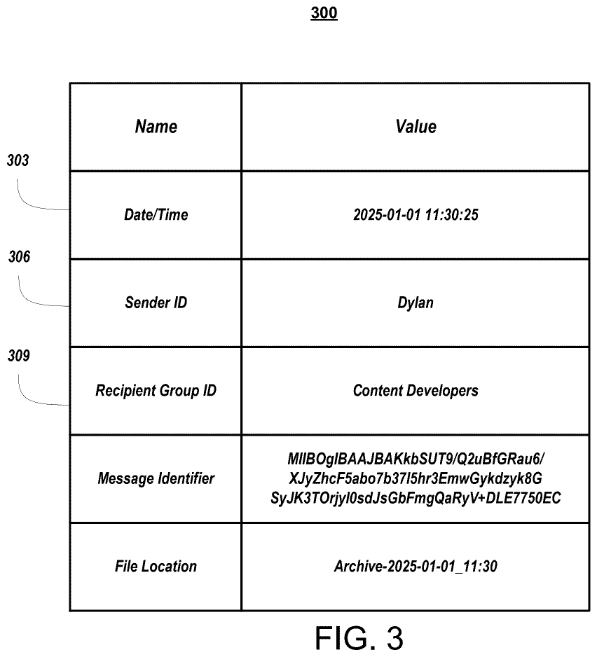

Before the message may be retrieved, each message goes through an archiving process. The archiving process involves receiving each message for the group that is being archived, decrypting the message, and then re-encrypting the message to be archived together with other messages within the group. As discussed above, the archiver (e.g., an archiving account or device) may be set up as a member of the group that is being archived. Accordingly, the archiver is enabled to receive and decrypt messages directed to the group that is being archived. The archiver (e.g., the archiving device) may perform the following operations to archive messages within the group. FIG. 3 describes the process.

In some embodiments, the archiver (e.g., the archiving device) executing message processing subsystem 116 may receive, from a server, an encrypted message to be assigned to or archived by the archiving device. As discussed above, a server may be configured to process encrypted messages for different groups. The server may receive messages from senders, determine, based on group membership, the users/devices that the messages need to be transmitted to, and transmit the messages to the appropriate devices. With the archiver configured to receive the messages for the group, the server may transmit each message to the archiver as though the archiver is a member of the group. The archiver (e.g., the archiving device) may receive the message and initiate the archiving process. In some embodiments, the archiver may be software code that has been installed on the server itself and the server may be sending the messages to itself (e.g., using a different port) so that the archiver is able to pick up the messages and initiate the archiving process.

When the archiver receives the encrypted message, the archiver may initiate the process to decrypt the message. In particular, message processing subsystem 116 may determine, based on message metadata associated with the encrypted message, a group identifier for a group to which the encrypted message is directed and a user identifier corresponding to a user that sent the encrypted message. The message metadata may be received together with the encrypted message. When the archiver receives the encrypted message, the archiver may extract message metadata from that message. The message metadata may include a number of fields. For example, the fields may include a group identifier of the group to which the message was sent and a user identifier associated with the sender of the encrypted message. Other fields may be stored within the metadata (e.g., cryptographic signature for sender authentication).

The archiver (e.g., the archiving device) may be configured to archive multiple groups. Thus, the group for which the message is being processed may be one of a plurality of groups assigned to archived by the archiving device. As discussed above, the archiver may be a member of each group that is being assigned to the archiver. Thus, the archiver may store group information (e.g., including a binary tree) for every group that is assigned to or being archived by the archiver. Accordingly, message processing subsystem 116 may access, based on the group identifier, a binary tree associated with the group. For example, message processing subsystem 116 may use the group identifier to perform a lookup to identify the matching binary tree. In some embodiments, the binary tree may store various information for decrypting group messages. For example, the binary tree may store a plurality of user identifiers of a plurality of users within the group. The binary tree may include, for each user and/or device within the group, a leaf node that may store one or more pieces of information. One of those pieces of information may be an identifier of the user corresponding to the leaf node.

Additionally or alternatively, the binary tree may store a plurality of key generation secrets. Each key generation secret may be a last generated key generation secret for a corresponding user. As discussed above, when a user sends a message, the binary tree is used to encrypt that message. The user's device may access the binary tree and use the last generated key generation secret as a seed to generate a key to encrypt the message together with the next key generation secret. In this instance, the last generated key generation secret may be used as a seed to generate a new key to decrypt the message and a new key generation secret. Accordingly, message processing subsystem 116 may locate, within the binary tree based on the user identifier, a leaf node representing the user. In some embodiments, each leaf node may represent a user device. Thus, message processing subsystem 116 may find a node that represents the sender's device or a sender's account.

When the leaf node is located, message processing subsystem 116 may continue the archiving process by decrypting the received message. In particular, message processing subsystem 116 may retrieve, from the leaf node, a latest key generation secret associated with the user. For example, message processing subsystem 116 may use an application programming interface or another suitable mechanism to request and/or retrieve information from the leaf node. The information may include the latest key generation secret.

Message processing subsystem 116 may then generate a decryption key for decrypting the received message so that the message can be analyzed and then encrypted for archiving. In particular, message processing subsystem 116 may generate, using a key generation algorithm, a subsequent key generation secret and a subsequent decryption key. The subsequent key generation secret and the subsequent decryption key may correspond to another set of a subsequent key generation secret and the subsequent encryption key separately generated on a device of the user. The subsequent encryption key may be one that was used to encrypt the encrypted message on the device of the user. That is, the decryption key may be a symmetric key that was used to encrypt the message and may now be used to decrypt the message. In some embodiments, the decryption key may not be the same as the encryption key. That is, the decryption and encryption keys may not be symmetrical but may use the same seed to be generated. For example, when the message was in the process of being encrypted on the sender's device, the algorithm may have used a last generated key generation secret as an input to an algorithm to generate an encryption key and a subsequent key generation secret. However, on the archiver, the algorithm may have generated a decryption key instead of an encryption key. In some embodiments, the encryption and decryption keys may be a public/private key pair.

Message processing subsystem 116 may then decrypt the encrypted message using the subsequent decryption key to generate a decrypted message. The decryption operation may result in the message being available in clear text. When the message has been decrypted, the message may be moved into a temporary location while the message is processed. In particular, message processing subsystem 116 may move the decrypted message into an encryption location. The encryption location (e.g., a queue) may be a temporary location that stores a plurality of decrypted messages for the group. In some embodiments, there may be multiple encryption locations (e.g., queues), with each queue corresponding to a particular group. In some embodiments, the temporary location may not be a queue but may be a space in memory or on a permanent storage. In some embodiments, the temporary location may be encrypted.

Message processing subsystem 116 may then encrypt the message for storing as art of the archive. In some embodiments, message processing subsystem 116 may encrypt the message by itself and store the message in a designated location. However, in some embodiments, message processing subsystem 116 may encrypt the message together with other messages for the group. In particular, message processing subsystem 116 may encrypt, using an encryption public key generated for a group administrator, the decrypted message and the plurality of decrypted messages into an encrypted file. For example, the encryption operation may be performed at a particular time interval. In some embodiments, the encryption operation may be performed when the temporary storage location (e.g., the encryption location or queue) grows to a particular number of messages or to a particular size (e.g., in memory or on permanent storage).

In some embodiments, message processing subsystem 116 may retrieve or generate metadata for each message being encrypted from the temporary storage (e.g., from the encryption location or queue). That is, the metadata operation may be performed together with the encryption operation. In particular, message processing subsystem 116 may perform the following operations when encrypting the decrypted message and the plurality of decrypted messages into the encrypted file. Message processing subsystem 116 may identify metadata associated with each message of the plurality of decrypted messages. The metadata may include one or more parameters. The parameters may be retrieved from the original encrypted message or from another location (e.g., group information, user information, etc.). In some embodiments, the parameters may include a corresponding sender identifier, a corresponding group identifier, a corresponding send date, a corresponding sender display name, and/or other suitable parameters. Message processing subsystem 116 may then store the metadata with a metadata store. The metadata may be stored with a link to the encrypted file.

FIG. 3 illustrates an excerpt of a data structure 300 for storing the metadata for a particular message. FIG. 3 may include a field 303 for storing a date and/or time when the message was sent. Field 306 may include a sender identifier. Field 309 may store a group identifier. In addition, the metadata may store a message identifier, a file identifier in which the message is located, and/or other suitable parameters. In some embodiments, in conjunction with metadata creation (e.g., when the message has been added to the temporary location), message processing subsystem 116 may transmit an acknowledgment to the server that the message has been prepared for archiving. That is, the server may refrain from delivering the encrypted message until the message has been decrypted and put into a temporary location for archiving. In particular, message processing subsystem 116 may, based on moving the decrypted message into the encryption location (e.g., queue), transmit an acknowledgment to the server that the encrypted message was received. Thus, the encrypted message may not be sent to group members until the acknowledgment is received by the server that is processing messages.

In some embodiments, the messages within the temporary location (e.g., within the encryption queue) may be encrypted using homomorphic encryption and may be manipulated in an encrypted form. In particular, message processing subsystem 116 may encrypt each message within the encryption location using a homomorphic encryption algorithm. While the message is encrypted, message processing subsystem 116 may manipulate the message and generate the required metadata. Furthermore, message processing subsystem 116 may encrypt metadata for each of the decrypted messages using the homomorphic encryption algorithm. Thus, the metadata may be stored in an encrypted format.

Message processing subsystem 116 may then store the encrypted file (e.g., in server 104). The encrypted file may be accessed by the archiving device for retrieving/reading encrypted messages. For example, message processing subsystem 116 may transmit the file to server 104. In addition, message processing subsystem 116 may transmit the metadata to be stored in a database (e.g., on server 104). When messages have been archived, message processing subsystem 116 may enable retrieving and reading the message to authorized users.

When the messages for a group have been archived, they may be retrieved from the archive so they can be reviewed. Message processing subsystem 116 may perform the retrieval operations discussed herein. Message processing subsystem 116 may receive a query to view one or more archived messages. The query may include the group identifier and a requesting user identifier. For example, message processing subsystem 116 may generate for display to a user (e.g., an administrator of the group) a graphical user interface where the user may be able to select a group, a time period, and/or other criteria for messages to view. When the user selects the criteria, that criteria may be submitted to message processing subsystem 116.

Message processing subsystem 116 may then determine whether the user is authorized to view the messages. In particular, message processing subsystem 116 may determine, based on the requesting user identifier, whether a requesting user is authorized to view the archived messages for the group. Message processing subsystem 116 may use various mechanisms to determine whether the user is authorized. In some embodiments, message processing subsystem 116 may perform the following operations to determine whether the user is authorized. Message processing subsystem 116 may search, using the requesting user identifier, for a user entry associated with the group. For example, the group may be associated with a data structure that may store all user identifiers for the members of the group. Each member may have a particular type of membership (e.g., administrator, non-administrator, etc.). In some embodiments, each user within the group data structure may have a flag indicating whether the user is an administrator. In yet some embodiments, only administrators may be flagged.

Message processing subsystem 116 may, upon locating the user identifier, determine whether the user is authorized. In particular, message processing subsystem 116 may determine whether the user entry includes a permission flag indicating that the requesting user is allowed to view the archived messages for the group. As discussed above, the flag may indicate whether the user is an administrator. In some embodiments, the flag may be specific for an archive reviewer. Thus, the user may have a role called archive reviewer, allowing the user access to the messages.

In some embodiments, message processing subsystem 116 may use the archiver public key and the archive private key for the group to determine whether the user is authorized. Message processing subsystem 116 may identify, using the group identifier, the archiver public key for the group. For example, message processing subsystem 116 may perform a lookup, using the group identifier, for the archiver public key. Message processing subsystem 116 may then generate an authorization token (e.g., an alphanumeric string) for authorizing the requesting user. The authorization token may be generated using a random number generator or using another suitable mechanism. Message processing subsystem 116 may then encrypt, using the archiver public key, an authorization token into an encrypted token. For example, message processing subsystem 116 may encrypt the token using the archiver public key so that a proper private key may be used to decrypt the encrypted token.

Message processing subsystem 116 may then transmit, to the requesting user, a request to authorize. The request may include the encrypted token so that it may be decrypted. For example, message processing subsystem 116 may send the encrypted token (e.g., together with the group identifier) to the device requesting to view the messages with a command to decrypt the token. The requesting device may use the group identifier to retrieve the corresponding archive private key and may decrypt the token. Once the token is decrypted, the requesting device may send the token back for the archiver to compare the token with the one that was generated. Message processing subsystem 116 may determine, based on a response token received from the requesting user, whether the requesting user is authorized. For example, if the requesting device does not have the archiver private key, then the token will not be correctly decrypted. Accordingly, message processing subsystem 116 may not give permission to such a device. However, if the token is properly decrypted, message processing subsystem 116 may determine that the user is authorized and proceed with the process.

Based on determining that the requesting user is authorized to view the archived messages for the group, message processing subsystem 116 may identify, using the group identifier in metadata associated with the group, one or more encrypted files responsive to or that match the query. For example, as discussed above, each message may be stored in an encrypted file containing a number of messages. Each file may have associated metadata (e.g., in a database) that may have message metadata for the messages stored in the file. For example, the metadata may be stored in a data structure such as a database table and include information such as a message identifier, date and time of the message, the sender of the message, the target group of the message, and/or other suitable parameters. Thus, message processing subsystem 116 may use the criteria received within the request to search the metadata to determine which encrypted files are responsive to the criteria. Message processing subsystem 116 may then transmit the one or more encrypted files to the requesting user.

In some embodiments, message processing subsystem 116 may process the message viewing request using the following operations. Message processing subsystem 116 may cause the one or more encrypted files to be decrypted. For example, message processing subsystem 116 may request the archiver private key from either the key vault or from the requesting user's device and use that archiver private key to decrypt the encrypted file or files.

Message processing subsystem 116 may store one or more decrypted messages retrieved from the one or more encrypted files in a temporary location. For example, message processing subsystem 116 may create a folder on the archiving device and temporarily store the encrypted files in that folder and decrypt those files. In some embodiments, before decrypting the encrypted files, message processing subsystem 116 may determine which messages are stored in which encrypted files.

Message processing subsystem 116 may then identify which messages within the encrypted file or files match the criteria. In particular, message processing subsystem 116 may select, based on criteria within the query, a plurality of messages matching the query. For example, one or more of the encrypted files may have messages that are responsive to the query and messages that are not responsive to the query. Thus, message processing subsystem 116 may want to only retrieve messages that are responsive to the query. Message processing subsystem 116 may determine (e.g., based on the message identifier and the metadata) those messages that are responsive to the query. Message processing subsystem 116 may then retrieve those messages.

In some embodiments, message processing subsystem 116 may determine which users correspond to which messages. Thus, message processing subsystem 116 may retrieve for the plurality of messages a plurality of user identifiers. For example, each message may be stored with metadata indicating the sender of the message, which may be a user identifier. The user identifier may be linked to a user object within the database. The user object may include user identifying information such as name, nickname(s), and/or other information. Thus, message processing subsystem 116 may retrieve, for each user identifier, a corresponding username. Message processing subsystem 116 may then, when displaying the messages, remove the user identifier with a corresponding username and/or one or more nicknames. Thus, message processing subsystem 116 may modify the plurality of messages with each corresponding username.

FIG. 4 is a diagram that illustrates an exemplary computing system 400, in accordance with embodiments of the present technique. Various portions of systems and methods described herein may include or be executed on one or more computer systems similar to computing system 400. Further, processes and modules described herein may be executed by one or more processing systems similar to that of computing system 400.

Computing system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a units-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application-specific integrated circuit). Computing system 400 may include a plurality of computing devices (e.g., distributed computer systems) to implement various processing functions.

I/O device interface 430 may provide an interface for connection of one or more I/O devices 460 to computing system 400. I/O devices may include devices that receive input (e.g., from a user) or output information (e.g., to a user). I/O devices 460 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computing system 400 through a wired or wireless connection. I/O devices 460 may be connected to computing system 400 from a remote location. I/O devices 460 located on a remote computer system, for example, may be connected to computing system 400 via a network and network interface 440.

Network interface 440 may include a network adapter that provides for connection of computing system 400 to a network. Network interface 440 may facilitate data exchange between computing system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Program instructions 470 may be executable by a processor (e.g., one or more of processors 410a-410n) to implement one or more embodiments of the present techniques. Instructions 470 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. Non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 420 may include a non-transitory, computer-readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices).

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 400 or multiple computer systems 400 configured to host different portions or instances of embodiments. Multiple computer systems 400 may provide for parallel or sequential processing/execution of one or more portions of the techniques described herein.

Those skilled in the art will appreciate that computing system 400 is merely illustrative and is not intended to limit the scope of the techniques described herein. Computing system 400 may include any combination of devices or software that may perform or otherwise provide for the performance of the techniques described herein. For example, computing system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 400 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

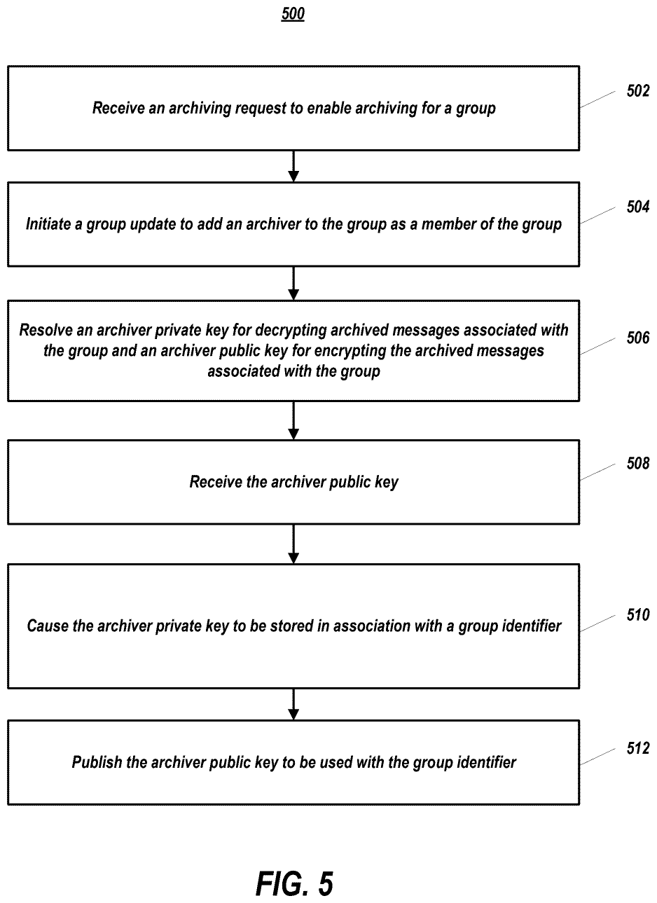

FIG. 5 shows an example flowchart 500 of operations for enabling archiving for a group. At 502, message archiving system 102 receives an archiving request to enable archiving for a group. For example, message archiving system 102 may be hosted on a computer system 400. Thus, the message may be received through network interface 440 (e.g., from a Bluetooth device) and then passed via I/O interface 450 to system memory 420. At 504, message archiving system 102 (e.g., using one or more components in environment 100 (FIG. 1) and/or computing system 400 via one or more processors 410a-410n and system memory 420 (FIG. 4)) initiates a group update to add an archiver to the group as a member of the group. At 506, message archiving system 102 (e.g., using one or more components in environment 100 (FIG. 1) and/or computing system 400 via one or more processors 410a-410n, I/O interface 450, and/or system memory 420 (FIG. 4)) resolves an archiver private key for decrypting archived messages associated with the group and an archiver public key for encrypting the archived messages associated with the group.

At 508, message archiving system 102 (e.g., using one or more components in environment 100 (FIG. 1) and/or computing system 400 via one or more processors 410a-410n (FIG. 4)) receives the archiver public key. At 510, message archiving system 102 (e.g., using one or more components in environment 100 (FIG. 1) and/or computing system 400 (FIG. 4)) causes the archiver private key to be stored in association with a group identifier. At 512, message archiving system 102 (e.g., using one or more components in environment 100 (FIG. 1) and/or computing system 400 via the network interface 440 (FIG. 4)) publishes the archiver public key to be used with the group identifier.

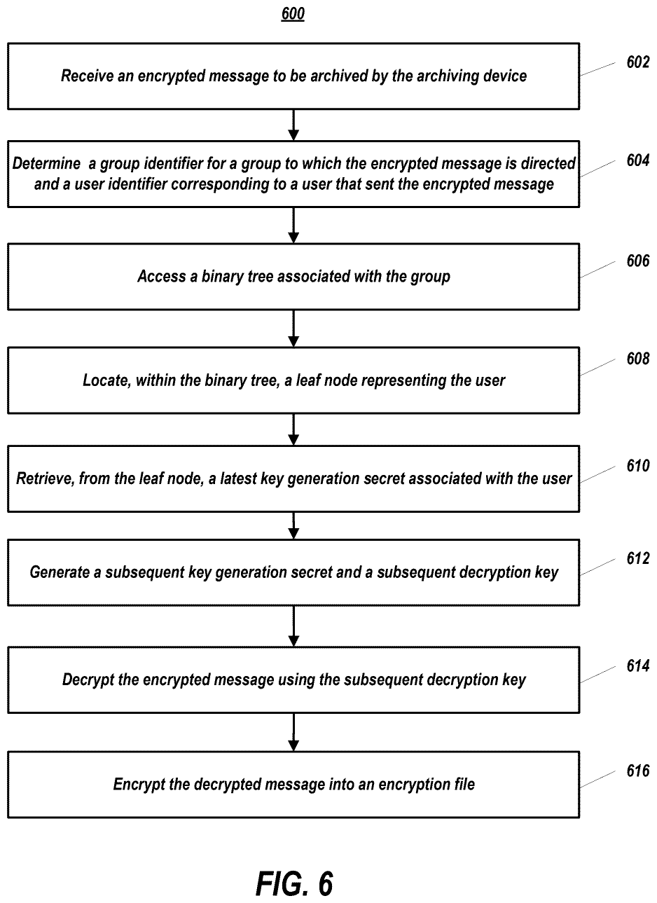

FIG. 6 shows an example flowchart 600 of operations for archiving messages. At 602, message archiving system 102 (e.g., using one or more components of computing system 400 via one or more processors 410a-410n (FIG. 4)) receives an encrypted message to be assigned to the archiving device. At 604, message archiving system 102 (e.g., using one or more components of computing system 400 via one or more processors 410a-410n (FIG. 4)) determines a group identifier for a group to which the encrypted message is directed and a user identifier corresponding to a user that sent the encrypted message. At 606, message archiving system 102 (e.g., using one or more components of computing system 400 via one or more processors 410a-410n (FIG. 4)) accesses a binary tree associated with the group. At 608, message archiving system 102 (e.g., using one or more components of computing system 400 via one or more processors 410a-410n (FIG. 4)) locates, within the binary tree, a leaf node representing the user. At 610, message archiving system 102 (e.g., using one or more components of computing system 400 via one or more processors 410a-410n (FIG. 4)) retrieves, from the leaf node, a latest key generation secret associated with the user.

At 612, message archiving system 102 (e.g., using one or more components of computing system 400 via one or more processors 410a-410n (FIG. 4)) generates a subsequent key generation secret and a subsequent decryption key. At 614, message archiving system 102 (e.g., using one or more components of computing system 400 via one or more processors 410a-410n (FIG. 4)) decrypts the encrypted message using the subsequent decryption key. At 616, message archiving system 102 (e.g., using one or more components of computing system 400 via one or more processors 410a-410n (FIG. 4)) encrypts the decrypted message into an encryption file.

It is contemplated that the actions or descriptions of FIG. 5 and FIG. 6 may be used with any other embodiment of this disclosure. In addition, the actions and descriptions described in relation to FIG. 5 and FIG. 6 may be done in alternative orders or in parallel to further the purposes of this disclosure. For example, each of these actions may be performed in any order, in parallel, or simultaneously to reduce lag or increase the speed of the system or method. Furthermore, it should be noted that any of the devices or components discussed in relation to FIGS. 1-4 could be used to perform one or more of the actions in FIG. 5 and/or in FIG. 6.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted; for example, such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third-party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other unmentioned benefits that will be apparent to those of skill in the art reviewing the present disclosure. Due to cost constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (i.e., meaning having the potential to) rather than the mandatory sense (i.e., meaning must). The words “include,” “including,” and “includes” and the like mean including but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompass both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D) unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques for performing archiving operations will be better understood with reference to the following enumerated embodiments:

1. A method comprising: receiving, at an archiving device from a server, an encrypted message to be assigned to the archiving device; determining, based on message metadata associated with the encrypted message, a group identifier for a group to which the encrypted message is directed and a user identifier corresponding to a user that sent the encrypted message; accessing, based on the group identifier, a binary tree associated with the group; locating, within the binary tree based on the user identifier, a leaf node representing the user; retrieving, from the leaf node, a latest key generation secret associated with the user; generating, using a key generation algorithm, a subsequent key generation secret and a subsequent decryption key, wherein the subsequent key generation secret and the subsequent decryption key correspond to the subsequent key generation secret and a subsequent encryption key generated on a device of the user, and wherein the subsequent encryption key was used to encrypt the encrypted message on the device of the user; decrypting the encrypted message using the subsequent decryption key to generate a decrypted message; encrypting, using an encryption public key generated for a group administrator, the decrypted message into an encrypted file; and storing the encrypted file, wherein the encrypted file is accessed by the archiving device.

2. The method of any of prior embodiments, wherein the binary tree stores (1) a plurality of user identifiers of a plurality of users within the group and (2) a plurality of key generation secrets, wherein each key generation secret of the plurality of key generation secrets is a last generated key generation secret for a corresponding user.

3. The method of any of prior embodiments, wherein the group is one of a plurality of groups assigned to the archiving device, and wherein the message metadata is received with the encrypted message.

4. The method of any of prior embodiments, further comprising: moving the decrypted message into an encryption location; and transmitting an acknowledgment to the server that the encrypted message was received, wherein the encrypted message is not sent to group members until the acknowledgment is received by the server.

5. The method of any of prior embodiments, wherein encrypting the decrypted message into the encrypted file further comprises: identifying metadata associated with the encrypted message, wherein the metadata comprises one or more of a corresponding sender identifier, a corresponding group identifier, a corresponding send date, or a corresponding sender display name; and storing the metadata with a metadata store, wherein the metadata is stored with a link to the encrypted file.

6. The method of any of prior embodiments, further comprising: encrypting each message within an encryption location using a homomorphic encryption algorithm; and encrypting metadata for each of the decrypted messages using the homomorphic encryption algorithm.

7. The method of any of prior embodiments, further comprising: receiving a query to view one or more archived messages, wherein the query comprises the group identifier and a requesting user identifier; determining, based on the requesting user identifier, whether a requesting user is authorized to view the one or more archived messages for the group; based on determining that the requesting user is authorized to view the one or more archived messages for the group, identifying, using the group identifier in metadata associated with the group, one or more encrypted files responsive to the query; and decrypting the one or more encrypted files into a temporary location.

8. The method of any of prior embodiments, wherein decrypting the one or more encrypted files further comprises: storing one or more decrypted messages retrieved from the one or more encrypted files in the temporary location; selecting, based on criteria within the query, a plurality of messages matching the query; retrieving for the plurality of messages corresponding user identifiers; retrieving, for each user identifier, a corresponding username; and modifying the plurality of messages with each corresponding username.

9. A tangible, non-transitory, machine-readable medium storing instructions that, when executed by a data processing apparatus, cause the data processing apparatus to perform operations comprising those of any of embodiments 1-8.

10. A system comprising: one or more processors; and memory storing instructions that, when executed by the processors, cause the processors to effectuate operations comprising those of any of embodiments 1-8.

11. A system comprising means for performing any of embodiments 1-8.

The present techniques for enabling archiving for a group will be better understood with reference to the following enumerated embodiments:

1. A method comprising: receiving an archiving request to enable archiving for a group, wherein the group is associated with a binary tree, and wherein the binary tree comprises a plurality of leaf nodes, with each leaf node of the plurality of leaf nodes representing a corresponding user within the group; initiating a group update to add an archiver to the group as a member of the group, wherein the archiver is added to the binary tree as a new leaf node; transmitting a command to an administrator device to resolve an archiver private key for decrypting archived messages associated with the group and an archiver public key for encrypting the archived messages associated with the group; in response to the command, receiving the archiver public key; causing the archiver private key to be stored in association with a group identifier corresponding to the group; and publishing the archiver public key to be used with the group identifier.

2. The method of any of prior embodiments, further comprising: receiving, at an archiving device, an update request for performing a group update operation, wherein the update request comprises one or more instructions for generating the binary tree that stores (1) a plurality of user identifiers of a plurality of users with the group and (2) master secret; and generating the binary tree for the group on the archiving device, wherein the binary tree includes a leaf node for the archiving device.

3. The method of any of prior embodiments, wherein transmitting the command to the administrator device to generate the archiver private key and the archiver public key further comprises: retrieving, from the archiving request, a user identifier associated with an administrator requesting that archiving be enabled; identifying, within a user dataset based on the user identifier, an address associated with the administrator device; and transmitting the command to the address associated with the administrator device.

4. The method of any of prior embodiments, further comprising: receiving a query to view one or more archived messages, wherein the query comprises the group identifier and a requesting user identifier; determining, based on the requesting user identifier, whether a requesting user is authorized to view the archived messages for the group; based on determining that the requesting user is authorized to view the archived messages for the group, identifying, using the group identifier in metadata associated with the group, one or more encrypted files responsive to the query; and transmitting the one or more encrypted files to the requesting user.

5. The method of any of prior embodiments, wherein determining whether the requesting user is authorized to view the archived messages for the group further comprises: searching, using the requesting user identifier, for a user entry associated with the group; and determining whether the user entry includes a permission flag indicating that the requesting user is allowed to view the archived messages for the group.

6. The method of any of prior embodiments, wherein determining whether the requesting user is authorized to view the archived messages for the group further comprises: identifying, using the group identifier, the archiver public key; encrypting, using the archiver public key, an authorization token into an encrypted token; transmitting, to the requesting user, a request to authorize, wherein the request comprises the encrypted token; and determining, based on a response token received from the requesting user, whether the requesting user is authorized.

7. The method of any of prior embodiments, further comprising: causing the one or more encrypted files to be decrypted; storing one or more decrypted messages retrieved from the one or more encrypted files in a temporary location; selecting, based on criteria within the query, a plurality of messages matching the query; retrieving for the plurality of messages a plurality of user identifiers; retrieving, for each user identifier, a corresponding username; and modifying the plurality of messages with each corresponding username.

8. A tangible, non-transitory, machine-readable medium storing instructions that, when executed by a data processing apparatus, cause the data processing apparatus to perform operations comprising those of any of embodiments 1-7.

9. A system comprising: one or more processors; and memory storing instructions that, when executed by the processors, cause the processors to effectuate operations comprising those of any of embodiments 1-7.

10. A system comprising means for performing any of embodiments 1-7.

What is claimed is:

1. A system for providing message archiving for groups, the system comprising:
one or more processors; and
a non-transitory computer-readable storage medium storing instructions, which when executed by the one or more processors cause the one or more processors to perform operations comprising:
receiving, at an archiving device from a server, an encrypted message to be archived by the archiving device;
determining, based on message metadata associated with the encrypted message, a group identifier for a group to which the encrypted message is directed and a user identifier corresponding to a user that sent the encrypted message, wherein the group is one of a plurality of groups assigned to the archiving device;
accessing, based on the group identifier, a binary tree associated with the group, wherein the binary tree stores (1) a plurality of user identifiers of a plurality of users within the group and (2) a plurality of key generation secrets, wherein each key generation secret of the plurality of key generation secrets is a last generated key generation secret for a corresponding user;
locating, within the binary tree based on the user identifier, a leaf node representing the user;
retrieving, from the leaf node, a latest key generation secret associated with the user;
generating, using a key generation algorithm, a subsequent key generation secret and a subsequent decryption key, wherein the subsequent key generation secret and the subsequent decryption key were separately generated on a device of the user, and wherein the subsequent decryption key was used to encrypt the encrypted message on the device of the user;
decrypting the encrypted message using the subsequent decryption key to generate a decrypted message;
moving the decrypted message into an encryption location, wherein the encryption location stores a plurality of decrypted messages for the group;
encrypting, using an encryption public key generated for a group administrator, the decrypted message and the plurality of decrypted messages into an encrypted file; and
storing the encrypted file, wherein the encrypted file is accessed by the archiving device.

2. The system of claim 1, wherein the instructions further cause the one or more processors to, based on moving the decrypted message into the encryption location, transmit an acknowledgment to the server that the encrypted message was received, wherein the encrypted message is not sent to group members until the acknowledgment is received by the server.

3. The system of claim 1, wherein the instructions for encrypting the decrypted message and the plurality of decrypted messages into the encrypted file further cause the one or more processors to perform operations comprising:
identifying metadata associated with each message of the plurality of decrypted messages, wherein the metadata comprises one or more of a corresponding sender identifier, a corresponding group identifier, a corresponding send date, or a corresponding sender display name; and
storing the metadata with a metadata store, wherein the metadata is stored with a link to the encrypted file.

4. The system of claim 1, wherein the instructions further cause the one or more processors to perform operations comprising:
encrypting each message within the encryption location using a homomorphic encryption algorithm; and
encrypting metadata for each of the decrypted message using the homomorphic encryption algorithm.

5. The system of claim 1, wherein the instructions further cause the one or more processors to perform operations comprising:
receiving a query to view one or more archived messages, wherein the query comprises the group identifier and a requesting user identifier;
determining, based on the requesting user identifier, whether a requesting user is authorized to view the one or more archived messages for the group;
based on determining that the requesting user is authorized to view the one or more archived messages for the group, identifying, using the group identifier in metadata associated with the group, one or more encrypted files matching the query; and
decrypting the one or more encrypted files into a temporary location.

6. The system of claim 5, wherein the instructions for decrypting the one or more encrypted files further cause the one or more processors to perform operations comprising:
storing one or more decrypted messages retrieved from the one or more encrypted files in the temporary location;
selecting, based on criteria within the query, a plurality of messages matching the query;
retrieving for the plurality of messages corresponding user identifiers;
retrieving, for each user identifier, a corresponding username; and
modifying the plurality of messages with each corresponding username.

7. A method for archiving group messages, the method comprising:
receiving, at an archiving device from a server, an encrypted message to be archived by the archiving device;
determining, based on message metadata associated with the encrypted message, a group identifier for a group to which the encrypted message is directed and a user identifier corresponding to a user that sent the encrypted message;
accessing, based on the group identifier, a binary tree associated with the group;
locating, within the binary tree based on the user identifier, a leaf node representing the user;
retrieving, from the leaf node, a latest key generation secret associated with the user;
generating, using a key generation algorithm, a subsequent key generation secret and a subsequent decryption key, wherein the subsequent key generation secret and the subsequent decryption key correspond to the subsequent key generation secret and a subsequent encryption key generated on a device of the user, and wherein the subsequent encryption key was used to encrypt the encrypted message on the device of the user;
decrypting the encrypted message using the subsequent decryption key to generate a decrypted message;
encrypting, using an encryption public key generated by a group administrator, the decrypted message into an encrypted file; and
storing the encrypted file, wherein the encrypted file is accessed by the archiving device.

8. The method of claim 7, wherein the binary tree stores (1) a plurality of user identifiers of a plurality of users within the group and (2) a plurality of key generation secrets, wherein each key generation secret of the plurality of key generation secrets is a last generated key generation secret for a corresponding user.

9. The method of claim 7, wherein the group is one of a plurality of groups archived by the archiving device, and wherein the message metadata is received with the encrypted message.

10. The method of claim 7, further comprising:
moving the decrypted message into an encryption location; and
transmitting an acknowledgment to the server that the encrypted message was received, wherein the encrypted message is not sent to group members until the acknowledgment is received by the server.

11. The method of claim 7, wherein encrypting the decrypted message into the encrypted file further comprises:
identifying metadata associated with the encrypted message, wherein the metadata comprises one or more of a corresponding sender identifier, a corresponding group identifier, a corresponding send date, or a corresponding sender display name; and
storing the metadata with a metadata store, wherein the metadata is stored with a link to the encrypted file.

12. The method of claim 7, further comprising:
encrypting each message within an encryption location using a homomorphic encryption algorithm; and
encrypting metadata for each of the decrypted message using the homomorphic encryption algorithm.

13. The method of claim 7, further comprising:
receiving a query to view one or more archived messages, wherein the query comprises the group identifier and a requesting user identifier;
determining, based on the requesting user identifier, whether a requesting user is authorized to view the one or more archived messages for the group;
based on determining that the requesting user is authorized to view the one or more archived messages for the group, identifying, using the group identifier in metadata associated with the group, one or more encrypted files matching the query; and
decrypting the one or more encrypted files into a temporary location.

14. The method of claim 13, wherein decrypting the one or more encrypted files further comprises:
storing one or more decrypted messages retrieved from the one or more encrypted files in the temporary location;
selecting, based on criteria within the query, a plurality of messages matching the query;
retrieving for the plurality of messages corresponding user identifiers;
retrieving, for each user identifier, a corresponding username; and
modifying the plurality of messages with each corresponding username.

15. One or more non-transitory computer-readable storage media storing instructions thereon, which when executed by one or more processors cause the one or more processors to perform operations comprising:
receiving, at an archiving device from a server, an encrypted message to be archived by the archiving device;
determining, based on message metadata associated with the encrypted message, a group identifier for a group to which the encrypted message is directed and a user identifier corresponding to a user that sent the encrypted message;
accessing, based on the group identifier, a binary tree associated with the group;
locating, within the binary tree based on the user identifier, a leaf node representing the user;
retrieving, from the leaf node, a latest key generation secret associated with the user;
generating, using a key generation algorithm, a subsequent key generation secret and a subsequent decryption key, wherein the subsequent key generation secret and the subsequent decryption key correspond to a subsequent encryption key and the subsequent key generation secret generated on a device of the user, and wherein the subsequent decryption key was used to encrypt the encrypted message on the device of the user;
decrypting the encrypted message using the subsequent decryption key to generate a decrypted message; and
encrypting, using an encryption public key generated by a group administrator, the decrypted message into an encrypted file.

16. The one or more non-transitory computer-readable storage media of claim 15, wherein the instructions further cause the one or more processors to perform operations comprising:
moving the decrypted message into an encryption location;
encrypting each message within the encryption location using a homomorphic encryption algorithm; and
encrypting metadata for each of the decrypted message using the homomorphic encryption algorithm.

17. The one or more non-transitory computer-readable storage media of claim 15, wherein the binary tree stores (1) a plurality of user identifiers of a plurality of users within the group and (2) a plurality of key generation secrets, wherein each key generation secret of the plurality of key generation secrets is a last generated key generation secret for a corresponding user.

18. The one or more non-transitory computer-readable storage media of claim 17, wherein the instructions further cause the one or more processors to perform operations comprising:
moving the decrypted message into an encryption location; and
transmitting an acknowledgment to the server that the encrypted message was received, wherein the encrypted message is not sent to group members until the acknowledgment is received by the server.

19. The one or more non-transitory computer-readable storage media of claim 15, where in the instructions further cause the one or more processors to perform operations comprising:
receiving a query to view one or more archived messages, wherein the query comprises the group identifier and a requesting user identifier;
determining, based on the requesting user identifier, whether a requesting user is authorized to view the one or more archived messages for the group;
based on determining that the requesting user is authorized to view the one or more archived messages for the group, identifying, using the group identifier in metadata associated with the group, one or more encrypted files matching the query; and
decrypting the one or more encrypted files into a temporary location.

20. The one or more non-transitory computer-readable storage media of claim 15, wherein the instructions for encrypting the decrypted message into the encrypted file further cause the one or more processors to perform operations comprising:
identifying metadata associated with each message of a plurality of decrypted messages within an encryption location, wherein the metadata comprises one or more of a corresponding sender identifier, a corresponding group identifier, a corresponding send date, or a corresponding sender display name; and
storing the metadata with a metadata store, wherein the metadata is stored with a link to the encrypted file.
